(19) United States
(12) Patent Application Publication
(10) Pub. No.: US 2010/0175231 A1
(43) Pub. Date: Jul. 15, 2010

(54) Device with Releasable Attachment Means

(75) Inventor: Karl-Heinz Lux, Weikersheim (DE)

Correspondence Address: GUDRUN E. HUCKETT DRAUDT, SCHUBERTSTR. 15A, WUPPERTAL, 42289, DE

(73) Assignee: BARTEC GMBH, Bad Mergentheim (DE)

(21) Appl. No.: 12/687,970

(22) Filed: Jan. 15, 2010

(30) Foreign Application Priority Data
Jan. 15, 2009 (DE) 10 2009 005 050.7

(51) Int. Cl. A44B 99/00; H01R 13/10

(52) U.S. Cl. 24/593.1; 24/591.1; 24/628; 439/682

(57) ABSTRACT

A device has a fastening device providing a releasable locking action on a support rail and further has a securing lever having a locked position in which the releasable locking action is secured against release. The device has a housing, wherein the fastening device is slidably arranged on a bottom plate of the housing. The fastening device has a base plate with at least one lock member interacting with the support rail. The at least one lock member has a cutout for receiving a transverse leg of the support rail and further has a ramp for the support rail.

### BACKGROUND OF THE INVENTION

The invention relates to a device with attachment means for releasably locking the device on a support rail.

It is an object of the present invention to further develop a device of the aforementioned kind such that with simple means a securing action of the locking system is achieved that secures reliably against vibrations, oscillations, and faulty operation and that can be quickly released in an uncomplicated way.

### SUMMARY OF THE INVENTION

In accordance with the present invention, this is achieved by a device comprising a fastening device for a releasable locking action on a support rail and comprising a securing lever that secures in its locked position the locking action between the support rail and the fastening device.

The fastening device is provided on a bottom plate of a housing.

The fastening device is slidably supported on the bottom plate of the housing.

The fastening device comprises a base plate on which at least one lock member interacting with the support rail is provided.

The lock member of the fastening device has a cutout for receiving a transverse leg of the support rail.

The lock member of the fastening device has a ramp for the support rail.

The fastening device comprises at least one securing stay that interacts with at least one securing rib of the bottom plate.

The securing stay of the fastening device is arranged in a gap between two securing ribs of the bottom plate.

The securing stay of the fastening device is arranged on a sidewall of the base plate.

The fastening device has at least one locking edge for the securing lever.

The locking edge is arranged on a sidewall of the base plate, preferably arranged on a projecting wall section of the sidewall.

The fastening device has correlated therewith at least one spring that moves the lock member in the direction toward the support rail.

The spring is a coil-shaped pressure spring and is supported on the base plate of the fastening device wherein one end of the spring engages a wall surface of the bottom plate of the housing and the other end of the spring is preferably supported on a rib of the base plate.

The fastening device has at least one locking tongue that interacts with the bottom plate of the housing.

The locking tongue is arranged on the base plate, projects from the plane of the base plate in the direction toward the bottom plate, and rests with an end face against a wall of the bottom plate.

The base plate of the fastening device has at least one engagement means for an auxiliary tool.

The fastening device comprising the base plate and two spaced-apart sidewalls is approximately U-shaped, wherein on the inner sides of the sidewalls that face one another at least one securing stay is provided, respectively, and wherein two spaced apart lock members, two springs, and two locking edges are provided.

The securing lever is arranged on the housing.

The securing lever has at least one locking edge for interacting with the locking edge of the fastening device.

The locking edge of the securing lever is provided on a projection of the securing lever that engages across the projecting wall section of the sidewall of the fastening device.

The securing lever is pivotably supported on the housing.

The pivotable support of the securing lever comprises at least one bearing part that is received in a bearing receptacle.

The bearing part is arranged on the securing lever and the bearing receptacle is provided on the support wall of the housing.

The securing lever is secured on the housing in a non-releasable way by a blocking device that comprises a blocking member preferably formed on the support wall which blocking member engages a blocking member receptacle provided on the securing lever.

The housing has two spaced-apart support walls each provided with a bearing receptacle and a blocking member, wherein the securing lever is embodied as an approximately U-shaped bracket with two legs and a grip part connecting the two legs, wherein the securing lever has on each one of the two legs a bearing part and a blocking member receptacle.

In the bearing part of the securing lever a preferably approximately semi-circular guide groove is formed which extends from an insertion opening provided at the circumferential rim of the bearing part approximately in radial direction toward the pivot axis of the securing lever.

The bearing receptacle in the support wall of the housing has an inlet opening that when the securing lever is pivoted into the release position is congruent with the insertion opening of the guide groove of the bearing part.

The securing lever is locked in its locked position against accidental return pivoting into the release position by an abutment resting against a stop of a locking cam.

The housing has a plug receptacle for a plug that is arranged on a module part that is lockable by the securing lever.

The plug receptacle of the housing has electric connectors for electric supply lines and/or electric outgoing lines and the module part contains electric and/or electronic components.

The module part is provided on at least one sidewall with at least one locking pin engaging a guide groove of the bearing part.

On at least one sidewall of the module part at least one stay is arranged that is guided in a longitudinal groove that is formed on the support wall of the housing and extends in the insertion direction of the module part.

After insertion of the locking pin into an insertion opening of the guide groove and minimal pivoting of the securing lever in the direction of the locked position the locking pin is secured in the guide groove against sliding out of the guide groove in a positive-locking way and between the plug and the plug receptacle a minimal contact spacing in accordance with the explosion protection regulations is provided.

### BRIEF DESCRIPTION OF THE DRAWING

FIG. 1 shows the device according to the invention in an exploded view.

FIG. 2 shows the device of FIG. 1 in a mounting position in the unlocked state with the securing lever in the release position.

FIG. 3 shows the device of FIG. 2 in the locked final assembly position.

FIG. 4 shows the device of FIG. 3 in a side view, partially in section.

FIG. 5 shows a detail view of the device according to detail V in FIG. 4, partially in section.

FIG. 6 shows the device of FIG. 4 with another partial section view

FIG. 7 shows a detail of the device according to the detail VII of FIG. 6, partially in section.

FIG. 8 shows the device of FIG. 4 and FIG. 6 in yet another section view.

FIG. 9 shows a detail of the device of FIG. 8 according to the detail IX of FIG. 7, partially in section.

### DESCRIPTION OF THE PREFERRED EMBODIMENTS

The device according to the present invention illustrated in the drawing can be embodied as an electrotechnical control or governing unit and can be provided for use in areas endangered by dust, dirt, moisture, splash water and ignitable atmosphere. The device is releasably locked by means of fastening device 1 on a support rail 2. The support rail 2 can be embodied as a so-called cap rail (top hat rail) that is in cross-section substantially U-shaped and has on the two parallel sidewalls a transverse leg 3, 4, respectively, extending away from one another in opposite directions.

The fastening device 1 is attached to a bottom plate 5 of a housing 6 and is slidably supported transversely to the longitudinal direction of the support rail 2. On that side of the support rail 2 that is opposite the fastening device 1, the housing 6 has a plug receptacle 7 that comprises several electric contact tubes 8 that are spaced apart from one another and have correlated therewith electric contacts, not illustrated, for contacting electrical supply lines and electrical outgoing lines.

The housing 6 comprises two support walls 9, 10 that are spaced apart from one another and parallel to one another and are connected by means of an end wall 11 arranged transverse to the support walls 9, 10 so that a receiving space delimited on three sides is formed. Each one of the two support walls 9, 10 is provided with a circular bearing receptacle 12 that are positioned opposite one another. Each bearing receptacle 12 has correlated therewith an inlet opening 13 that is formed in the support walls 9, 10 as a slot-shaped cutout.

Moreover, the support walls 9, 10 each have on their inner sides a longitudinal groove 14, oppositely positioned to one another, and on their exterior sides a locking cam 15, respectively, also oppositely positioned. Also, the support walls 9, 10 each have a blocking member 16 that is arranged adjacent to the circumferential rim of the bearing receptacle 12.

Between the support walls 9, 10 of the housing 6 a module part 17 is insertable that is substantially embodied as a rectangular body and has on its bottom side facing the housing 6 a plug 18. The plug 18 is surrounded by a circumferential wall comprised of four wall parts wherein neighboring wall parts are positioned at a right angle to one another. The circumferential wall surrounds several electric contact pins that are spaced apart from one another and are connected conductingly to electric or electronic components that are located within the module part 17. The contact pins of the plug 18 are insertable into the contact tubes 8 of the plug receptacle 7.

On spaced-apart parallel sidewalls 19, 20 of the module part 17 there are wall sections 21 that are somewhat recessed inwardly and are delimited by a wave-shaped edge contour. The wall sections 21 each have a locking pin 23; the locking pins 23 are positioned opposite one another and project in opposite directions and outwardly. Moreover, on the exterior sides of the wall sections 21 there is a stay 24, respectively, and the stays 24 are positioned opposite one another. The stays 24 are engaged by the longitudinal grooves 14 of the support walls 9, 10. In accordance with the edge contour 22 the outer rims of the support walls 9, 10 also have an approximately wave-shaped end face contour 25 that matches the edge contour 22 in the completely assembled state. The recess depth of the wall sections 21 corresponds approximately to the thickness of the support walls 9, 10 that rests against the wall sections 21.

Moreover, a securing lever 26 is provided that is comprised of two spaced apart, parallel legs 27, 28 and a grip part 29 that is slightly curved and connects the legs 27, 28 so that the securing lever 26 is substantially embodied as a U-shaped bracket. The securing lever 26 is arranged on the support walls 9, 10 of the housing 6 and is pivotably supported. For this purpose, on the inner faces of the legs 27, 28 a bearing part 30 is arranged at the free ends, respectively, and these bearing parts 30 are positioned mirror-symmetrically opposite one another and each have a guide groove 31. The bearing parts 30 are embodied as circular disks and are positive-lockingly (form-fittingly) supported in the bearing receptacles 12 of the support walls 9, 10 wherein the center axes of the annular bearing parts 30 form the pivot axis of the securing lever 26.

Adjacent to the circumferential area of the bearing parts 30 a blocking member receptacle 32 is formed on the legs 27, 28 of the securing lever 26, respectively. The blocking members 16 of the support walls 9, 10 engage positive-lockingly these receptacles 32 in such a way that the securing lever 26 is secured captively in its end positions as well as during its pivot movement and cannot be removed.

The guide grooves 31 are arranged approximately radially in the bearing part 30 and extend from an insertion opening 33 formed at the circumferential rim of the bearing parts 30 approximately semi-circularly in the direction toward the center axis of the bearing part 30. The width of the guide grooves 31 is sized such that they are approximately identical or only slightly greater than the diameter of the locking pins 23 so that the latter are guided substantially without play in the guide grooves 31.

On the inner sides of the two legs 27, 28 of the securing lever 26 there are two abutments 34 that are mirror-symmetrically positioned opposite one another and rest against a stop 35 of the locking cams 15. A ramp 36 for the locking cam 15 is arranged in front of the abutments 34 and a recess 37 is arranged behind the abutments 34, respectively. Moreover, the securing lever 26 has on its legs 27, 28 nose-shaped projections 38 that have on their inner sides mirror-symmetrically arranged opposed locking edges 39.

The fastening device 1 is substantially U-shaped and has a base plate 40 with two monolithically formed sidewalls 41, 42 that are spaced apart from one another and project from the plane of the base plate 40 at a right angle upwardly. Approximately at the longitudinal center of the sidewalls 41, 42 there is a monolithically formed wall section 43 that extends upwardly and is of a rectangular shape. A locking edge 44 is formed on the wall section 43.

On the facing inner sides of the sidewalls 41, 42 several securing stays 45 are arranged in a row behind one another parallel to the base plate 40 such that gaps 46 between the securing stays 45 are provided. When the fastening device 1 is mounted on the bottom plate 5 of the housing 6, the securing stays 45 interact with securing ribs 47 that are arranged on opposed sides of the bottom plate 5 also in a row behind one another. Between the individual securing ribs 47 there are spacings 48 that are engaged by the securing webs 45 of the fastening device 1 wherein the securing ribs 47 are positioned in the gaps 46.

In an edge area of the base plate 40 that extends transversely between the sidewalls 41, 42 two lock members 49 can be arranged that are spaced apart from one another and are expediently embodied monolithically with the base plate 40. The lock members 49 are provided for locking engagement of the support rail 2. For this purpose, the lock members 49 can each have a cutout 50 that is engaged upon locking at the support rail 2 by the transverse leg 3. In order to facilitate mounting for the locking action, it can be advantageous to provide on the side of the lock members 49 facing the support rail 2 a ramp 51 that is slanted upwardly in the direction toward the cutout 50 and across which the outer edge of the transverse leg 3 will glide during the locking process.

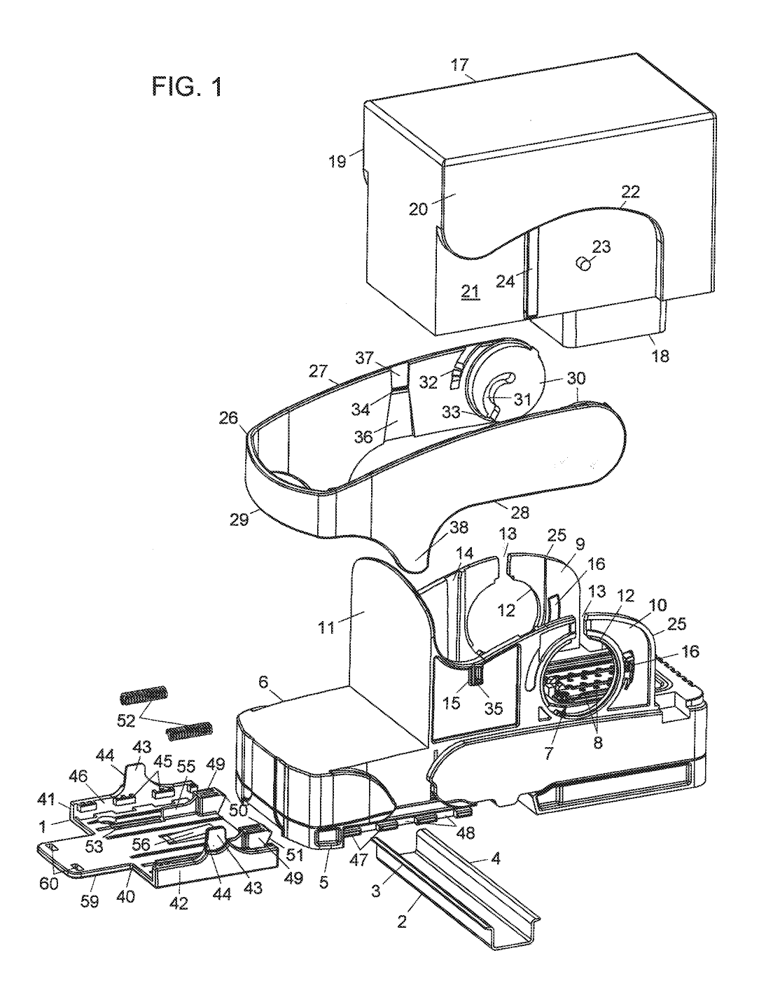

Moreover, two springs 52 are provided that are preferably embodied as coil-shaped pressure springs. The springs 52 can be oriented in the longitudinal direction transversely to the support rail 2 and can be supported on the base plate 40 of the fastening device 1 preferably each in a longitudinal depression 53. Between the two springs 52 or the longitudinal depressions 53 there is a spacing that is approximately the same as the spacing between the two lock members 49. The springs 52 force the fastening device 1 that is slidably supported on the bottom plate 5 in the direction toward the support rail 2. For this purpose, one end of the springs 52 is resting against a wall surface 54 of the bottom plate 5. The other end of the springs 52 is supported on a rib 55 of the base plate 40 (FIG. 7). The ribs 55 are arranged between the wall of the lock members 49 opposite the ramp 51 and an end of the longitudinal depressions 53 and are monolithically formed with the base plate 40 and the lock members 49 (FIG. 1).

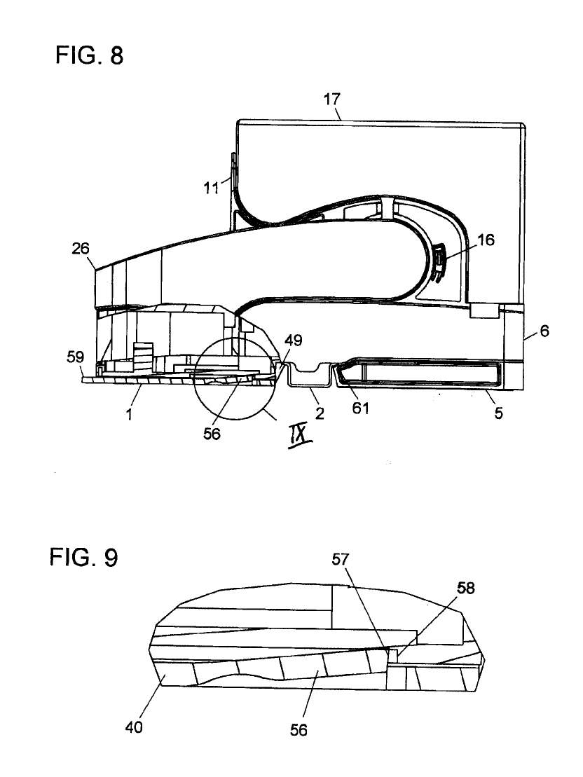

In the space between the two lock members 49 approximately at the center of the base plate 40, a locking tongue 56 is arranged on the base plate 40, preferably monolithically formed with the base plate 40 (FIGS. 8 and 9). The rectangular locking tongue 56 is expediently designed such that one of its narrow ends is formed integrally with the base plate 40. The locking tongue 56 itself extends from this attached narrow end at a slant upwardly past the plane of the base plate 40 so that it counteracts in a springy fashion a pressure being applied from above. When the fastening device 1 is mounted the locking tongue 56 is locked at the bottom plate 5 wherein an end face 59 of the locking tongue 56 opposite the attached narrow end interacts with a wall 58 of the bottom plate 5.

On the side opposite the lock members 49 the base plate 40 of the fastening device 1 has a tongue 59 that extends within the plane of the base plate 40 and has two engagement means 60 that are formed as bores into which an auxiliary tool can be inserted. When the housing 6 is to be removed from the support rail 2 the fastening device 1 can be moved against the force of the springs 52 so that the lock members 49 are removed from the support rail 2 and release its transverse leg 3.

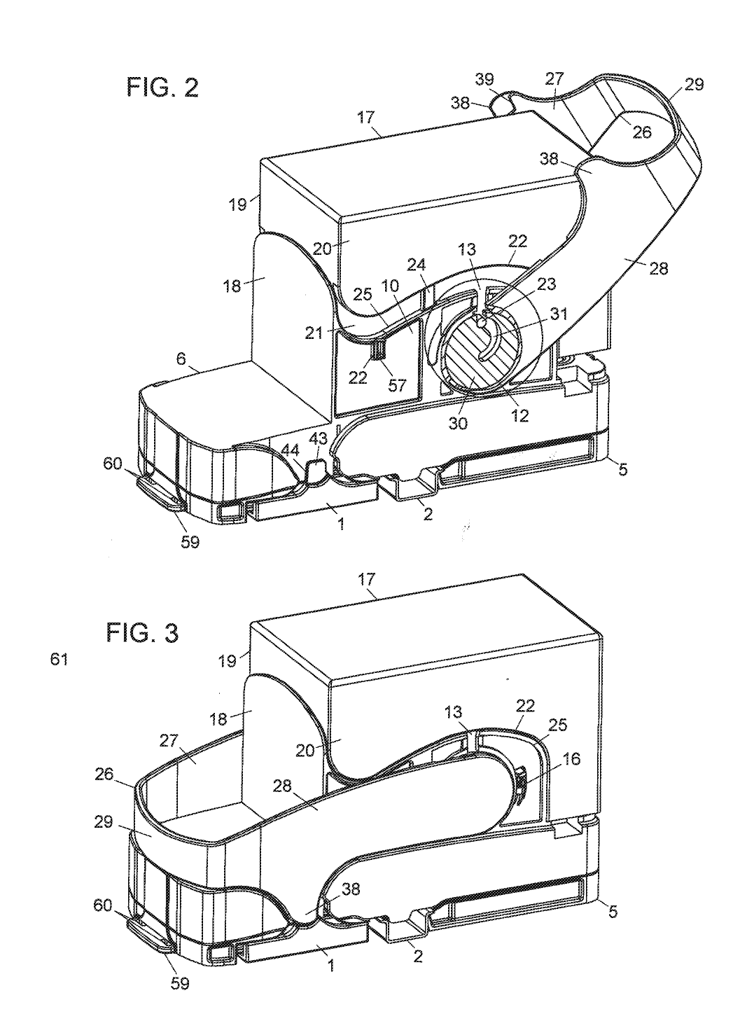

When the module part 17 is to be inserted into the housing 6, first the securing lever 26, as shown in FIG. 2, is moved in the clockwise direction all the way to the rear into a limited release position. In this position, the inlet openings 13 of the support wall 9, 10 and the insertion openings 33 of the bearing parts 30 are congruent. The module parts 17 is then inserted into the receiving space of the housing 6 that is delimited by the support walls 9, 10 and the end face 11 on three sides such that the stays 24 engage the longitudinal grooves 14 and the locking pins 23 pass through the insertion openings 33 into the beginning of the guide grooves 31.

A further downward pressing or downward pushing of the module part 17 in the direction toward the housing 6 is no longer possible. The module part 17 can be moved farther in the direction toward the housing 6 only by pivoting the securing lever 26 counterclockwise; when doing so the locking pins 23 are forcedly guided in the guide grooves 31. As soon as the securing lever 26 has been pivoted somewhat in the counterclockwise direction, the locking pins 23 are engaged from above within the guide grooves 31.

In this position the plug 18 of the module part 17 is already located within the plug receptacle 7 of the housing 6. The contact pins of the plug 18 correspond not yet with the contact tubes of the plug receptacle 7. Between the free ends of the contact pin and the tube openings of the contact tubes, an axial minimum contact spacing in accordance with the regulations of DIN EN 50018 and DIN EN 60079 exists. Since the module part 17 in this position is already secured by the positive-locking (form-fitting) engagement of the locking pins 23, an explosion-like counterpressure within the plug connection, for example, can no longer cause the module part 17 to be forced away from the housing 6 in the upward direction.

In FIG. 3 the final assembly position is illustrated in which the plug 18 of the module part 17 has been inserted completely into the plug receptacle 7 of the housing 6 and the contact pins are located within the contact tubes. The securing lever 26 has been pivoted in the counterclockwise direction into its horizontal locked position. During the pivoting action, the ramps 36 of the securing lever 26 glide across the locking cams 15 of the support walls 9, 10 shortly before reaching the locked position and at the end of the pivot movement the locking cams 15 snap into place in the recesses 37 of the securing lever 26 so that the abutments 34 rest against the stops 35 of the locking cams 15. In this way an accidental upward pivoting of the securing lever 26 in the clockwise direction is safely prevented and a stable fixation of the locked position is ensured.

In the illustrated locked position of the securing lever 26 its projections 38 engage across the wall sections 43 of the fastening device 1. In this connection, the locking edges 44 of the wall sections 43 rest on the locking edges 39 of the projections 38 and prevent thus a horizontal displacement of the fastening device 1. In this way, the locking action of the fastening device 1 on the support rail 2 is reliably secured against accidental release even in case of vibrations or oscillations. The fastening device 1 can be displaced against the force of the springs 52 by means of the auxiliary tool causing the lock members 49 to move away from the support rail 2 only and only when prior to this the securing lever 26, after overcoming the locking cams 15, has been pivoted in the clockwise direction in the direction toward the release position.

Even when the module part 17, for example, in case of a defect, is to be exchanged during operation, first the securing lever 26 is to be pivoted into the release position illustrated in FIG. 2 wherein the module part 17 by the eccentric forced guiding action of the locking pins 23 is moved away from the housing 6 upwardly so that the plug connection is decoupled. After reaching the release position of the securing lever 26 the module part 17 can be manually removed in the upward direction out of the receiving space of the housing 6 and a new one can be inserted.

The module part 17 can advantageously be exchanged without any risk even in explosion-hazardous environments during operation without the electric device having to be switch off. No fixed connectors must be detached, As a result of the explosion-protected embodiment, neither upon insertion nor removal of the module part 17 sparks generated in the interior of the plug connection can escape to the exterior and cause ignition in an explosive environmental atmosphere; as a whole a great safety standard is provided.

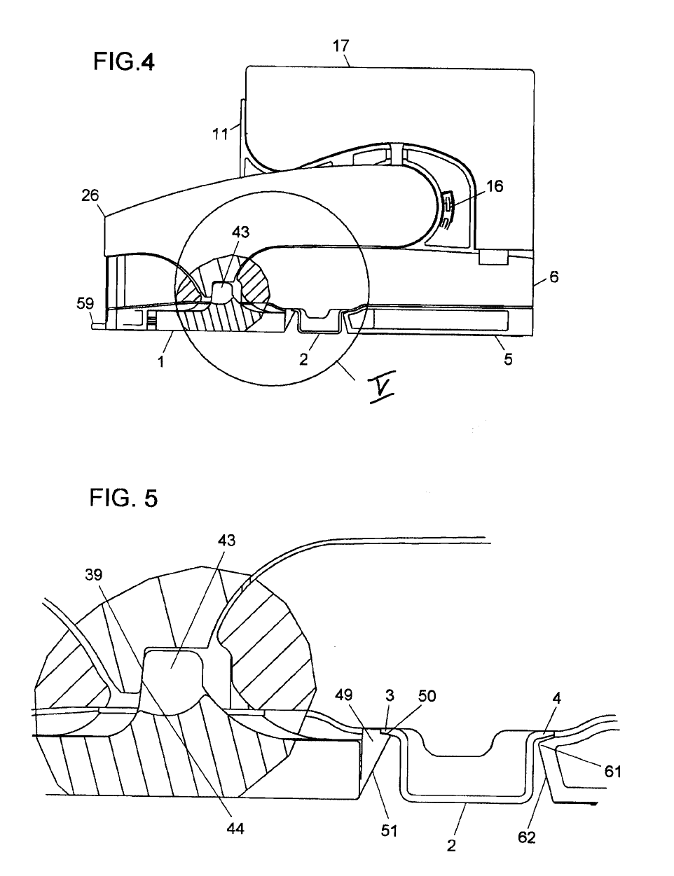

FIGS. 4 and 5 show that the transverse leg 4 of the support rail 2 shown to the right in the drawing is engaged from below by a nose 61 of the bottom plate 5. The nose 61 has a ramp 62 arranged in front of it. Upon locking the housing 6 on the support rail 2, the outer edges of the transverse legs 3, 4 glide along the ramp 51 and the ramp 62 wherein the lock members 49 are moved to the left slightly against the force of the springs 52. As soon as the housing 6 is resting on the support rail 2, wherein the nose 61 engages the transverse leg 4, the lock members 49 snap into place as a result of the force of the springs 52 underneath the transverse leg 3 so that the latter engages the cutout 50. In this way, the housing 6 is locked on the support rail 2. With the securing lever 26 in the locked position, the locking edges 44 of the wall sections 43 rest against the locking edges 39 of the projections 38 so that the fastening device 1 with the lock members 49 cannot be moved away from the support rail 2 and an absolutely safe securing action is ensured.

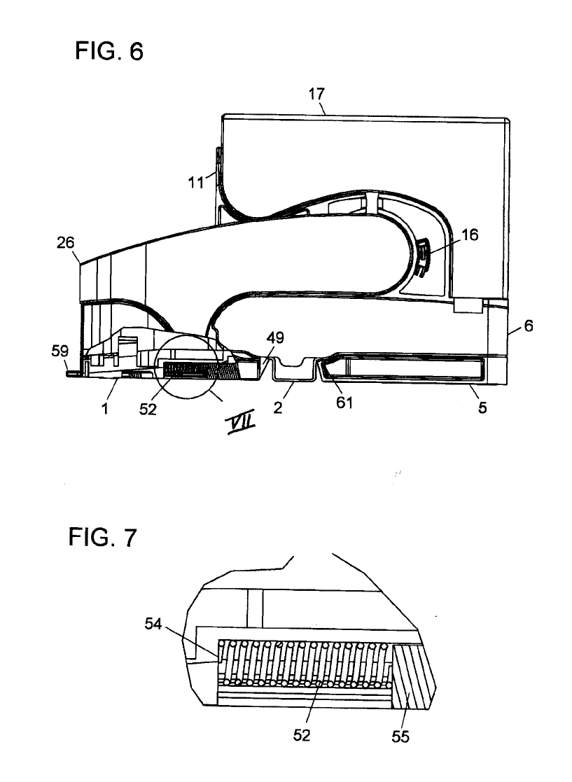

FIGS. 6 and 7 illustrate in particular the arrangement of the springs 52. It can be seen that a left end of the spring rests against the wall surface 54 of the bottom plate 5. The right end of the springs 52 is supported on the rib 55 of the base plate 40.

FIGS. 8 and 9 show the positioning of the fastening device 1 on the bottom plate 5. The locking tongue 56 that is formed integrally by means of its left narrow end on the base plate 40 projects at a slant upwardly into the area of the bottom plate 5 so that the free end face 57 of locking tongue 56 interacts with the wall 58 of the bottom plate 5.

The specification incorporates by reference the entire disclosure of German priority document 10 2009 005 050.7 having a filing date of Jan. 15, 2009.

While specific embodiments of the invention have been shown and described in detail to illustrate the inventive principles, it will be understood that the invention may be embodied otherwise without departing from such principles.

What is claimed is:

1. A device comprising a fastening device providing a releasable locking action on a support rail and further comprising a securing lever having a locked position in which said releasable locking action is secured against release.

2. The device according to claim 1, comprising a housing, wherein said fastening device is slidably arranged on a bottom plate of said housing, wherein said fastening device has a base plate with at least one lock member interacting with the support rail, wherein said at least one lock member comprises a cutout for receiving a transverse leg of said support rail and further comprises a ramp for the support rail.

3. The device according to claim 2, wherein said fastening device has at least one securing stay provided on a sidewall of said base plate and wherein said bottom plate has securing ribs, wherein said at least one securing stay and said securing ribs interact with one another, wherein said at least one securing stay is received in a gap between two of said securing ribs.

4. The device according to claim 2, wherein said fastening device has at least one locking edge for said securing lever, wherein said at least one locking edge is provided on a sidewall of said base plate on a projecting wall section of said sidewall.

5. The device according to claim 2, wherein said fastening device has at least one spring forcing said at least one lock member in a direction toward the support rail, wherein said at least one spring is a coil pressure spring and is supported on said base plate, wherein said at least one spring has a first end engaging a wall surface of said bottom plate of said housing and a second end supported on a rib of said base plate.

6. The device according to claim 5, wherein said fastening device comprises two spaced-apart sidewalls connected to opposite ends of said base plate and projecting upwardly from said base plate so that said base plate and said two sidewalls define a U-shape, wherein on facing inner sides of said two sidewalls at least one securing stay is provided, respectively, wherein two said lock members are provided and are spaced apart from one another, wherein two said springs are provided, and wherein each one of said sidewalls has a locking edge for said securing lever.

7. The device according to claim 2, wherein said fastening device has at least one locking tongue interacting with said bottom plate of said housing, wherein said at least one locking tongue is arranged on the base plate and projects past a plane of said base plate upwardly in a direction toward said bottom plate of said housing and rests with an end face on a wall of said bottom plate.

8. The device according to claim 2, wherein said securing lever is arranged on said housing and has at least one locking edge interacting with a locking edge of said fastening device, wherein said securing lever has a projection and said at least one locking edge of said securing lever is arranged on said projection, wherein said projection engages across a projecting wall section of a sidewall of said fastening device.

9. The device according to claim 2, wherein said securing lever is pivotably supported on said housing and comprises at least one bearing part arranged in a bearing receptacle.

10. The device according to claim 9, wherein said at least one bearing part is arranged on said securing lever and said bearing receptacle is arranged in a support wall of said housing.

11. The device according to claim 10, wherein in said at least one bearing part a guide groove is provided that is approximately semi-circular and that extends from an insertion opening provided at a circumferential rim of said at least one bearing part approximately radially in a direction toward a pivot axis of said securing lever, wherein said bearing receptacle has an inlet opening provided in a support wall of said housing, wherein said inlet opening and said insertion opening in a release position of said securing lever are congruent with one another and wherein said securing lever in said locked position is secured against accidental pivoting into said release position by an abutment resting against a stop of a locking cam provided on a support wall of said housing.

12. The device according to claim 11, wherein said housing has a plug receptacle for a plug provided on a module part that is insertable into said housing and securable by said securing lever, wherein said module part has at least one sidewall provided with a locking pin engaging said guide groove of said at least one bearing part, whereon on said at least one sidewall of said module part at least one stay is arranged that engages a longitudinal groove provided in a support wall of said housing and extending in a direction of insertion of said module part into said housing.

13. The device according to claim 12, wherein after insertion of said locking pin into said insertion opening and slight pivoting of said securing lever in a direction of said locked position said locking pin is secured positive-lockingly in said guide groove against sliding out of said guide groove and wherein a minimum contact spacing in accordance with explosion protection regulations exists between said plug and said plug receptacle.

14. The device according to claim 2, wherein said securing lever is non-releasably secured on said housing by a blocking device comprising a blocking member arranged on a support wall of said housing and a blocking member receptacle formed on said securing lever.

15. The device according to claim 2, wherein said housing has a plug receptacle for a plug provided on a module part that is insertable into said housing and securable by said securing lever.

16. The device according to claim 15, wherein said plug receptacle has electric connectors correlated with electric supply lines and electric outgoing lines and wherein said module part contains electric and/or electronic components.
